(19) United States
(12) Patent Application Publication
(10) Pub. No.: US 2026/0241479 A1
(43) Pub. Date: Aug. 20, 2026

(54) MULTI-PIECE CONTACT FOR AN END ASSEMBLY OF A WELDING DEVICE

(71) Applicant: ELCo Enterprises, Inc., Jackson, MI (US)

(72) Inventors: Edward L. Cooper, Clarklake, MI (US); Steven J. Hayes, Addison, MI (US)

(21) Appl. No.: 19/105,933

(22) PCT Filed: Aug. 24, 2023
(86) PCT No.: PCT/US2023/031016

§ 371 Date: Feb. 24, 2025

Related U.S. Application Data
(60) Provisional application No. 63/401,231, filed on Aug. 26, 2022.

(51) Int. Cl. B23K 9/173; B23K 9/26

(52) U.S. Cl. CPC B23K 9/173; B23K 9/26

(57) ABSTRACT

A contact tip for an end assembly of an arc welding system includes a body that is a separate piece relative to a cap that is assembled with the body. The body is made of a higher conductive material such as copper, and the cap is made of a higher temperature resistance material such as tungsten copper. The body is configured to conduct the current of the welding system, the with cap resisting the high temperatures of the welding process to increase wear resistance and durability. The body includes a projecting boss that is received in a corresponding bore of the cap. The boss includes external threads and the bore includes corresponding internal threads. The body and cap each include central bores that combine to define an overall bore through assembled multi-piece contact tip.

### CROSS-REFERENCE TO RELATED APPLICATIONS

This PCT International Application claims the benefit of U.S. Provisional Patent Application No. 63/401,231, filed Aug. 26, 2022, the entire content of which is hereby incorporated by reference in its entirety.

### FIELD

The present invention relates to welding devices and systems. In particular, the present invention relates to a contact tip for an end assembly of a welding device for feeding a wire electrode.

### BACKGROUND

Metal Inert Gas (MIG) welding also referred to as “wire-feed” or Gas Metal Arc Welding (GMAW) utilizes heat from an electrical arc to melt a consumable electrode to form a weld on a workpiece. A MIG welding system typically includes a power supply, a gas supply and an electrode supply connected to a welding device or welding gun. A ground cable is used to connect the workpiece to the power supply. The welding device generally includes a handle, a gooseneck and an end assembly. The welding system can be automatic or semi-automatic and may be manually or robotically controlled. The electrode and gas are coupled through a conduit in the handle and the gooseneck to the end assembly of the welding device. The electrode extends through the contact tip of the end assembly and the gas moves around the contact tip in the nozzle of the end assembly. When the welding device is activated, the electrode is fed through the contact tip toward the workpiece and the gas is directed through the nozzle towards the workpiece. When the electrode is placed adjacent to or in contact with the workpiece, the electrode completes an electrical circuit between the power supply and the workpiece, allowing current to flow through the electrode to the workpiece. The current produces an arc between the electrode and the workpiece. The heat of the arc melts the electrode and the workpiece in the region surrounding the arc, creating a weld puddle. The gas flowing out the nozzle shields the weld puddle from atmospheric gases and outside contaminants. The type of gas used in MIG welding varies depending on many factors. Noble or inert gases such as Argon are often used. However, Carbon Dioxide (CO₂) and a mixture of gases such as CO₂ and Argon are also used. Once the electrode is moved away from the workpiece, the electric circuit is broken and the weld puddle cools and solidifies, forming a weld.

During repeated use of the end assembly during a welding process, the contact tip may become worn or otherwise misshapen or damaged, thereby requiring replacement, which is time-consuming and expensive. In some cases, the contact tip is tightly secured within the end assembly such that disassembly and replacement may require additional time and expense, leading to further costs associated with downtime.

Accordingly, improvements can be made in the construction of contact tips for use in end assemblies of a welding device.

### SUMMARY

The contact tip and end assembly of the present disclosure may be used with a welding device for GMAW. In one embodiment, the end assembly includes a gooseneck, a diffuser body, a contact tip and a nozzle. The components of the end assembly are secured together so as to share a common axis.

The diffuser body features a passageway for allowing shielding gas to flow into an annular space between the diffuser body, contact tip and nozzle.

However, it will be appreciated that the contact tip may be used with other end assembly arrangements.

Further still, the present disclosure relates to a contact tip for a welding device having a radiused or rounded convex curved first end, and a radiused or rounded second end with a center bore extending therethrough. The second end of the diffuser body has buttress threads with mate with buttress threads located near the first end of the contact tip. The diffuser body has a radiused or rounded concave surface. When the contact tip is attached to the diffuser body, the mating concave and convex surfaces are brought into direct contact, providing excellent thermal and electrical conductivity between these components. The threads may be other types of threads, and may mate with other structure of the end assembly while still being brought into engagement with the concave surface of the diffuser body.

In one aspect, the contact tip is a multi-material and multi-piece contact tip, with a body portion and a cap portion removably attached to the body portion. The cap may be threaded onto the body portion and swedged onto the body portion. In another aspect, the cap and body may have corresponding tapered surfaces rather than being pressed and swedged together. The threads between the cap and the body portion may be buttress threads or standard threads.

The cap may have a rounded end that is presented at the location of the weld puddle during a welding operation. The opposite end of the contact tip assembly, at the base, includes a rounded, radiused, curved, and/or convex surface configured to mate with a corresponding surface of the diffusor.

In one aspect, the base portion is copper, and the cap portion is a tungsten-copper. The cap portion provides a longer lasting tip at the area of the contact tip that undergoes the greatest amount of wear. The tungsten copper material has higher wear properties than copper. The base portion, made of copper, has higher conductivity than the tungsten-copper tip. Thus, the use of both the tungsten-copper tip combined with the copper base provides both high conductivity and higher wear resistance than a one-piece structure made of either tungsten-copper alone (reduced conductivity) or copper alone (reduced wear resistance). The enhanced wear resistance of the cap provides a long-lasting contact tip assembly, such that replacement of the cap may not be necessary.

The body portion, being made of copper, retains high conductivity, affordability, and ease of manufacturing relative to one-piece designs made of higher cost proprietary materials and/or high difficulty machining. To the extent that the tungsten-copper cap is more difficult to machine and more expensive, the size of the cap portion relative to the body portion is much smaller, thereby reducing the effect of the higher cost and manufacturing difficulty. For example, the tungsten-copper cap may be a sintered component, which may typically be provided in 12-18″ bars of material, which can be difficult to machine into a complete one-piece contact tip, even if conductivity were sufficient.

The multi-piece contact tip assembly does not degrade as quickly as a one-piece copper contact tip, and therefore does not require replacement as frequently as the one-piece copper contact tip. Typically, for a one-piece contact tip, high heat at the welding pool causes copper to become deformed. When the copper tip gets hot at the end near the weld pool, the heat may rise to the annealing temperature of the copper, and the copper gets softer. When the copper at the end of the contact tip gets softer, the wire electrode passing through the end of the contact tip can cause the exit hole to wear into an oval shape, thereby increasing the amount of play between the wire and the end of the contact tip. This stretching out of the bore at the end of the contact tip leads to reduced accuracy in the placement of the wire, thereby affecting the weld pool, which can move the root of the weld out of the desired/original position. Additionally, when the end of the contact tip wears, micro-arcing in the tip can result, thereby causing increased wear at the end of the tip. The multi-piece contact tip with the cap portion attached to the copper body portion addresses these issues and thereby provides substantial advantages.

The substance and advantages of the present invention will become further apparent by reference to the following drawings and the description.

### BRIEF DESCRIPTION OF THE DRAWINGS

FIG. 1 is a schematic illustration of a GMAW welding system of a prior art design.

FIG. 2 is a longitudinal cross-sectional view of an end assembly of a prior art GMAW welding system.

FIGS. 3A-3D are exploded and assembled views of a multi-piece and multi-material contact tip having a cap that is threaded onto a body.

FIGS. 4A-4C are detail views of the body of the multi-piece contact tip, illustrating a boss portion with external threads configured to be received in the cap.

FIGS. 5A-5D are detail views of the cap of the multi-piece contact tip, illustrating an internal bore with internal threads configured to receive the boss portion of the body in threaded engagement.

### DETAILED DESCRIPTION

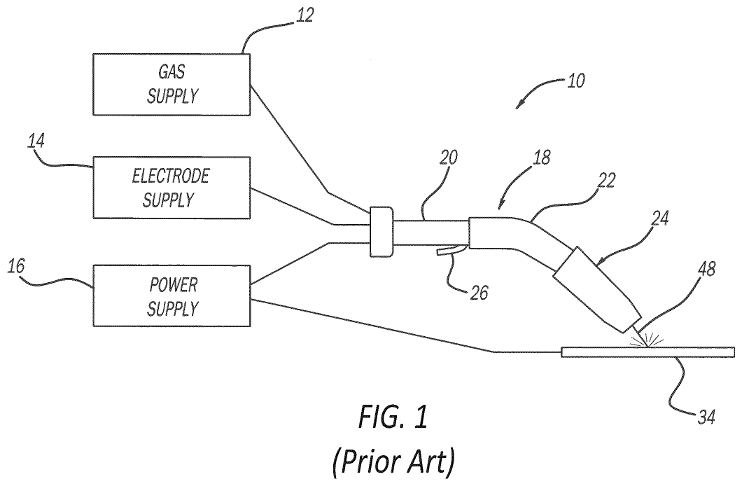

FIG. 1 is a general, schematic representation of MIG welding system 10. The welding system 10 includes gas supply 12, electrode supply 14, and electrical power supply 16 connected to welding device 18. In general, welding device 18 includes handle 20, gooseneck 22 and end assembly 24. Welding device 18 also includes an activation switch which, in one embodiment, is trigger 26 on handle 20. Welding system 10 is used to perform a welding operation on workpiece 34. It is understood that the welding system 10 can be operated similar to welding systems well known in the art.

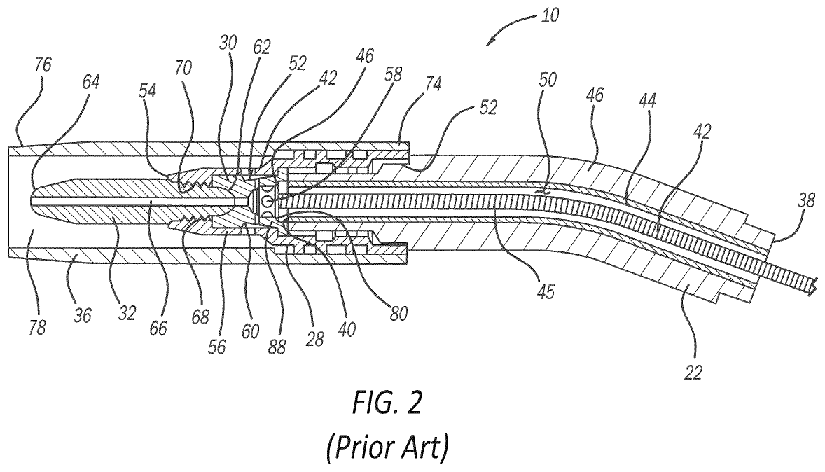

FIG. 2 shows a design of end assembly 10 in accordance with a prior art design having gooseneck 22, diffuser sleeve 28, insert 30, contact tip 32 and nozzle 36. In one aspect, the insert 30 and diffusor sleeve 28 may be formed integrally as one-piece of the same material, and it will be appreciated that reference to the insert 30 includes reference to the similar portion of diffusor sleeve 28 sized and shaped similar to the illustrated insert. It will be appreciated that other diffuser sleeve sizes and shapes may also be used. Gooseneck 22 has opposed first and second ends 38 and 40, with passageway 42 extending therebetween. First end 38 of the gooseneck 22 is connected to handle 20 of welding device 18. Gooseneck 22 includes inner conduit 44 which extends between ends 38 and 40, and forms passageway 42. Inner conduit 44 is constructed of an electrically conductive material. In the example presented, inner conduit 44 is made of copper. Wire guide 45 is formed from a wound wire and is a flexible cable having a center bore for allowing passage of electrode 48. Gooseneck 22 also includes outer housing 46 or covering which protects inner conduit 44. Passageway 42 of gooseneck 22 is sized to enable wire guide 45, electrode 48 and gas 50 to move through the passageway from first end 38 will.

Diffuser sleeve 28 has opposed first and second open ends 52 and 54, with wall 56 therebetween, forming inner cavity 58. First end 52 of diffuser sleeve 28 is mounted on second end 40 of gooseneck 22. Inner cavity 58 extends between open first end 52 and open second end 54. The size and shape of inner cavity 58 of diffuser sleeve 28 varies depending on the type of gooseneck 22, the size and shape of the diffusor sleeve (including separate or integral insert 30), and the type of contact tip 32 used. Wall 56 has a least one radially extending passageway 60. In one embodiment, wall 56 has a plurality of passageways 60 spaced around the perimeter of the wall. Passageways 60 in wall 56 are in fluid communication with gooseneck passageway 42.

Contact tip 32 is connected to second end 54 of diffuser sleeve 28. First end 62 of contact tip 32 extends into inner cavity 58 of diffuser sleeve 28. Center bore 66 of contact tip 32 extends along the longitudinal axis of the contact tip. When contact tip 32 is secured in second end 54 of diffuser sleeve 28, center bore 66 of contact tip 32 is coaxial with the longitudinal axis of the diffuser sleeve. In one embodiment, external threads 68 are formed adjacent to first end 62 of contact tip 32 which mate with internal threads 70 on the interior surface of inner cavity 58 of diffuser sleeve 28. Threads 68 and 70 are preferably formed as buttress profile threads. However, other end assembly arrangements are also possible, in which the contact tip may be engaged with and secured with the end of the diffuser sleeve 28 without being directly threaded into the diffusor sleeve. For example, the threads of the contact tip 32 may engage with the nozzle 36, which itself engages with the diffuser sleeve 28, or an additional sleeve may engage with the diffuser sleeve or gooseneck and pull the contact tip 32 into engagement with the end of the diffuser sleeve 28.

In the prior art example presented, first end 62 of the contact tip 32 has a radiused or rounded convex outer end surface. Second end 64 of contact tip 32 is also radiused. Nozzle 36 has open second end 76 with gas channel 78 surrounding contact tip 32. When nozzle 36 is secured on diffuser sleeve 28 (in one of a variety of securement methods), the nozzle extends outward from first end 74 along diffuser sleeve 28 toward second end 76 so that diffusor sleeve 28 is in gas channel 78. Nozzle 36 extends along contact tip 32 so that contact tip 32 is in gas channel 78.

Insert portion 30 of diffusor sleeve 28 (or similar internal portion of a unitary one-piece structure) has a first end 80 and a second end 82 and forms at least one radial passageway 88. Passageways 88 are in fluid communication with gooseneck passageway 42 and sleeve passageway 60. Shielding gas flowing into gooseneck 22 escapes into the radial gap situated between tip 32 and nozzle 36 to provide shielding gas flow to the weld site.

In the prior art example presented, the inner surface of insert second end 82 is formed with a radiused or rounded concave surface which matches first end 62 of the contact tip 32. This contact at the concave and convex surfaces provides excellent electrical and thermal conductivity between tip 32 and insert 30. When insert portion 30 is instead integrated with the diffusor sleeve 28 as a one-piece structure, radial bores or passageways extending from inner cavity 58 to gas channel 78 may be provided, thereby allowing shielding gas to flow to the weld site from the gooseneck 22.

It will also be appreciated that the specific attachment stack-up may be varied, such that the diffusor sleeve 28 may attached to the inner diameter of the gooseneck 22, and the nozzle may attach directly to the gooseneck 22 at its outer diameter, such that the nozzle is not directly attached to the diffusor sleeve 28. Other variations are also possible. In one example, the diffusor sleeve 28 could be integrally formed with the end of the gooseneck 22.

It will be appreciated that the details of providing a consumable electrode, shielding gas, and electricity to a welding system need not be described in detail, and that further discussion will be directed to the multi-piece contact tip of the present disclosure that provides the benefits and improvement apparent herein.

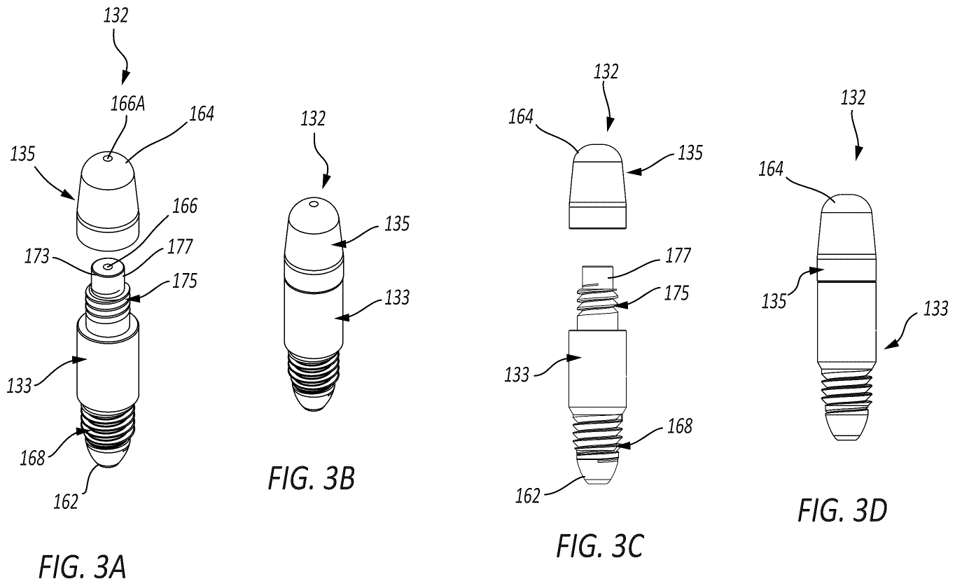

Now with reference to FIGS. 3-5, a first embodiment of a multi-piece contact tip 132 is illustrated, having a body portion or body 133 and a cap portion or cap 135 that is assembled with the body 133. Body 133 may, in one aspect, may be made of copper. Cap 135 may, in one aspect, be made of tungsten-copper. The material of body 133 is preferably one of high conductivity, with the material of cap 135 being one of higher durability and with higher resistance to temperature that will occur at the weld site, even with reduced conductivity. It will be appreciated that materials other than the specifically disclosed copper and tungsten-copper may be used.

FIGS. 3A-D illustrates contact tip 132 in both exploded views and assembled views. The body 133 may be provided separate from the cap 135, with the body 133 and cap 135 being different materials. The cap 135 may then be threaded onto the body, thereby securing the cap 135 to the body 133 and defining the multi-piece contact tip 132.

The cap 135 may be press-fit and swedged onto the body 133, with the cap 135 compressing and deforming material of the body 135 as the corresponding threads therebetween become engaged and secured. In one aspect, a tightening tool with multiple points of contact may be applied to the outer surface of the cap 135 during assembly, which may deform the corresponding engaged threads during a final tightening step to reduce instances where the threads could become disengaged during repeated use of the corresponding welding system.

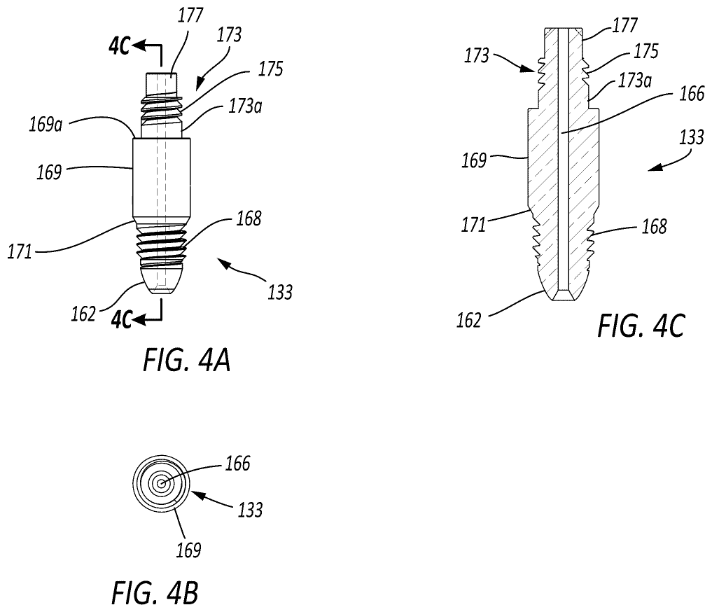

Turning now to FIGS. 4A-C, body 133 is shown in further detail, including in cross-section. Body 133 includes first end 162 of contact tip 132, having a radiused or rounded convex outer end surface. External threads 168 are located adjacent the non-threaded portion of the first end 162. The non-threaded portion, which includes the radiused or rounded convex outer end surface, is the portion that mates with the corresponding concave curved structure of the diffusor sleeve 28 or similar corresponding concave curved structure of an end assembly of a welding device. These corresponding curved surfaces are convex/concave in a curved manner, which is intended to distinguish relative to generally constant sloped (flat) tapered surface when viewed in cross-section, or a plurality of flat tapered surfaces. It will be appreciated that due to manufacturing limitations that some very small flat surfaces may be present along the curved concave/convex profiles of this interface. It will also be appreciated that the curvatures may differ slightly and still be considered to be corresponding curved surfaces, in view of the material compression that will occur during the tightening and pressing of the two pieces together.

The external threads 168 are sized and shaped to correspond to internal threads of the end assembly, such as threads 70 of the diffusor sleeve 28 (or other threads of other components of the end assembly). The threads 168 and 70 may be in the form of buttress threads, in one aspect. External threads 168 transition to central body portion 169 via a tapered section 171, with central body portion 169 defining an outermost diameter of the body 133. In one aspect, the outer diameter of central body portion 169 defines the outmost diameter of the overall assembled contact tip 132, with cap 135 having a maximum diameter that is the same or reduced relative to the diameter of the central body portion 169.

Body 133 further includes boss 173 that projects axially from the central body portion 169 in a direction opposite relative to the first end 162. A ledge portion 169a is defined at the interface between the boss 173 and central body portion 169, with the boss having a reduced diameter relative to the central body portion 169. The ledge 169a provides a surface against which the cap 135 may bear during assembly of the cap 135 to the body 133.

Boss 173 includes external threads 175 along a middle portion thereof, and further includes end portion 177 that includes the terminal end of body 133. End portion 177 is non-threaded and adjacent the threads 175. As shown, end portion 177 has a generally cylindrical shape. The end portion 177 is sized to correspond generally to an interior shape of the cap 135, thereby providing a locating feature during assembly of the cap 135 and body 133. In one aspect, a further non-threaded base portion 173a is provided axially between the threads 175 and the central body portion 169.

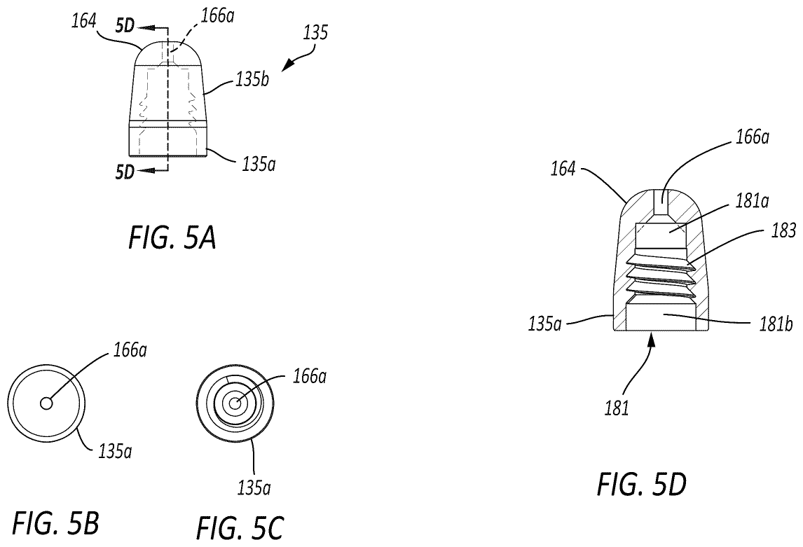

In one aspect, the threads 175 may extend further than illustrated and into the non-threaded portions adjacent the threads 175. In one aspect, the non-threaded portions may have tapered shapes rather than cylindrical shapes (shown in broken line in FIGS. 4C and 5D). In one aspect, the end portion 177 may have a rounded convex shape.

Central bore 166 extends fully through body 133, including through first end 162, central body potion 169, and boss 173. Central bore 166 is sized and shaped to guide the weld wire that passes through the contact tip 132. The central bore 166 may include a larger diameter, tapered entrance portion (shown at the bottom of FIG. 4C) where the weld wire enters and is guided axially through the bore 166. The central bore 166 will continue through the cap 135 when the body 133 and cap 135 are assembled together to define the contact tip 132. The central bore 166 is shown as being round/circular throughout the figures. However, the bore 166 may have other cross-section shapes, such as an oval or ellipse shape to accommodate non-round weld wire to allow for controlled orientation of a non-round weld wire.

Turning now to FIGS. 5A-D, cap 135 is shown in further detail, including in cross section. Cap 135 includes a base section 135a configured to bear against the ledge 169a of central body portion 169 of the body 133. Base section 135a is shown having a generally cylindrical shape. Base section 135a transitions to tapered section 135b, which transitions to end portion 164, defining the terminal end of the overall multi-piece contact tip. The end portion 164 defines a curved convex outer surface. However, end portion 164 is not configured to mate with a corresponding recess or cavity. Rather, end portion 164 is the end of the contact tip 132 configured for being located adjacent the weld pool and at which high temperatures are experienced. The end portion 164 of cap 135, as well as the base section 135a and tapered section 135b, operates to insulate the boss 173 of the body 133. The material of cap 135 has higher resistance to temperature than the material of the body 133.

While not apparent from the outside of the cap 135, cap 135 defines a bore 181 sized and shaped to correspond to that of boss 173 that projects axially from the body 133. Bore 181 includes internal threads 183 sized and shape to correspond to the external threads 175 of boss 173. Threads 175 and 183 may be in the form of buttress threads, in one aspect. After assembly of the cap 135 on the body 133, it is possible to deform the threads 175 and 183 to provide additional securement of the cap 135 to the body 133.

Bore 181 further includes non-threaded cavities, including tip cavity 181a and base cavity 181b. Tip cavity 181a is located adjacent the terminal end of end portion 164, and base cavity 181b is located adjacent base section 135a. Tip cavity 181a may be nominally sized to correspond to end portion 177 of the boss 173, and base cavity 181b may be nominally sized to correspond to non-threaded base portion 173a of boss 173.

Base section 135a may have an outer diameter that corresponds to the outer diameter of the central body portion 169 of the body 133, such that when assembled, the cap 135 smoothly transitions to the body 133, and vice versa.

When assembled, as the threads become engaged and the cap 135 is threaded down onto the body 133, the boss may become slightly compressed axially and slightly deformed such that the cap 135 and body 133 are “swedged” together.

Cap 135 includes central bore 166a, sized and shaped similarly to bore 166 of the body 133. When assembled, bores 166a and 166 are aligned to define an overall bore extending through the contact tip 132. As described above with reference to bore 166, the bore 166 may have a non-round cross-section. In one aspect, one of bore 166a and bore 166 may have a non-round cross-section, with the other having a round cross section having a diameter at least as large as the major diameter of the non-round bore. Thus, due to the rotational connection of the cap 135 being threaded onto the body 133, the non-round wire may still pass fully through the contact tip 132.

In one aspect, the bore 166a of the cap 135 may include a larger diameter entry portion adjacent the tip cavity 181a. It is possible that when assembled, the cap 135 and body 133 may have bores that are very slightly misaligned due to tolerances. Thus, the larger diameter tapered entry portion of the bore 166a can account for any very slight misalignment, thereby allowing the weld wire to continue through the contact tip 132 without issue.

The cap 135 and body 133 are preferably assembled together prior to assembly into a welding system end assembly. However, it will be appreciated that the cap 135 may be assembled onto the body 133 after the body 133 has already been assembled with the diffusor 28 or other component designed to the receive the body 133.

Once assembled as part of the end assembly, the contact tip 132 will provide the same operable ability to guide the weld wire to the weld site and provide ample conductivity for creating the desired weld. While the temperature at the weld site increases, the cap 135, being of a material having higher temperature resistance, will resist the increase in temperature and provide increased durability without sacrificing weld performance. The contact tip 132 will not become substantially worn or soften and deform over periods of extended use, thereby preserved the efficiency of the welding process and reducing the frequency of required replacement.

The dimensions described herein are provided for reference only, and shall not be interpreted as limiting the illustrated components to the cited dimensions. The dimensions herein and appearance in the drawings may be relied on for deducing relative sizing among components as shown in the drawings, however the illustrated relative sizing shall also not be interpreted as being limiting. The example dimensions are shown in U.S. Provisional Patent Application No. 63/401,231, filed Aug. 25, 2022, which are incorporated by reference in their entirety.

With reference to FIG. 4A-4C, the following dimensions (in inches) are illustrated. Beginning in FIG. 4A, at the bottom of portion 163 being 0.000, the bottom of the threads 168 is at 0.153, the top of the threads 168 is at 0.429, the top of tapered portion 171 is at 0.472, the top of portion 169 is at 0.957, the top of the threads 175 is at 1.207, and the top of portion 177 is at 1.357. The radius at the bottom of 162 is 0.094, the radius of the side of 163 is 0.375. A 0.005 chamfer at 45 degrees is provided at the outer edges of 169a. The threads 175 are ¼-20 buttress threads. The threads 168 are 5/16-20 buttress threads. In FIG. 4B, the outer diameter of 169 is 0.354. The diameter of bore 166 is 0.052+/−0.002 through. The diameter of the tapered portion that leads into the bore 166 is 0. 132 at 60 degrees. In FIG. 4C, the diameter of 177 is 0.1875, the diameter of the threads 175 is 0.250, the diameter of threads 168 is 0.304, the diameter of the top of 162 is 0.257. The inner diameter of the 0.094 radius at the bottom of 162 is 0.111 and its outer diameter is 0.160.

With reference to FIGS. 5A-D, the following dimensions (in inches) are illustrated. In FIG. 5A, with the bottom of 135a being 0.000, the top of the cylindrical portion leading to the tapered portion 135b is at 0.135, and the bottom of the tapered shape of 135b is 0.165. The top of the tapered shape is at 0.416. A radiused transition between the bottom cylindrical shape and the tapered shape 135b is 0.313. The diameter of the bottom of 135b is 0.351. The diameter of the top of 135b is 0.303. The top of 164 is at 0.525. The radius of 164 is 0.125. In FIG. 5B, the outer diameter of 135a is 0.354. The diameter of bore 166 a is 0.052+/−0.002 through. The beginning/end of the 0.125 radius of 164 is at diameter 0.055. In FIG. 5D, with the bottom of 135a being 0.000, the top of 181b is at 0.100, the bottom of 181a is at 0.305, the top of 181a is 0.400 to 0.402. The angle measured between opposite sides of the taper of 135b is 11 degrees. The diameter of 181a is 0.1875. The angle measured between the inner surfaces of the tapered portion leading into bore 166a is 90 degrees. The diameter of the bottom edge of this tapered portion 0.115. The diameter of 181b is 0.250. The inner diameter of the threads 183 is 0.194. The threads 183 are ¼-20 buttress threads.

In the foregoing description, various features of the present invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated by reference herein in their entirety, with each claim standing on its own as a separate embodiment of the present invention.

It is intended that the foregoing description be only illustrative of the present invention and that the present invention be limited only by the hereinafter appended claims.

While the above description constitutes the preferred embodiment of the present invention, it will be appreciated that the invention is susceptible to modification, variation and change without departing from the proper scope and fair meaning of the accompanying claims.

We claim:

1. A contact tip for use with an end assembly for an arc welding device of a type including a gooseneck having an internal passageway for conducting a shielding gas, a diffusor coupled to the gooseneck, a nozzle extending from the gooseneck, and a wire guide for guiding a consumable wire electrode, the contact tip comprising:
a body made of a first material and defining a first end of the contact tip configured to mate with an end assembly of a welding system;
a first set of external threads formed on the body and located adjacent the first end, wherein the external threads are configured to engage corresponding threads of the end assembly;
a cap made of a second material different from the first material and defining a second end of the contact tip configured for feeding a weld wire therefrom to a weld site, the cap sized and shaped to mate with the body, wherein the cap is a separate piece that is assembled with the body to define the contact tip;
an overall central bore defined by the body and the cap and extending fully through the contact tip, the overall central bore configured to feed a weld wire therethrough;
wherein the first material of the body has higher conductivity than the second material of the cap; and
wherein the second material of the cap has a higher temperature resistance than the first material of the body.

2. The contact tip of claim 1, wherein the first end defines a convex end surface surrounding a central longitudinal axis defined by the body, wherein the convex end surface is non-threaded and configured to mate with a corresponding concave surface of the end assembly.

3. The contact tip of claim 1, wherein the body includes a boss portion extending in a direction opposite the first end, the boss portion configured to be received within a corresponding bore of the cap.

4. The contact tip of claim 3, wherein the boss portion includes external threads and the bore includes internal threads.

5. The contact tip of claim 4, wherein the boss portion and bore are sized such that the cap and body are swedged in response to threading the cap onto the body.

6. The contact tip of claim 4, wherein the boss portion includes a non-threaded end portion and the bore includes a non-threaded tip cavity sized to receive the non-threaded end portion.

7. The contact tip of claim 3, wherein the body has a central body portion, and the boss portion has a smaller diameter than an outer diameter of the central body portion.

8. The contact tip of claim 7, wherein the cap has an outer diameter corresponding to the outer diameter of the central body portion.

9. The contact tip of claim 7, wherein the central body portion defines an annular ledge, wherein the cap bears against the annular ledge when assembled with the body.

10. The contact tip of claim 3, wherein the cap includes a base portion that transitions to a tapered portion that transitions to the second end of the contact tip, wherein the base portion has an outer diameter corresponding to the body when assembled.

11. The contact tip of claim 1, wherein the body is copper and the cap is tungsten-copper.

12. The contact tip of claim 3, wherein the boss portion includes a tapered non-threaded end portion and the cap has a corresponding tapered cavity that receives the tapered non-threaded end portion when assembled.

13. The contact tip of claim 1, wherein the body defines a first central bore and the cap defines a second central bore, wherein the first and second central bore combine to define the overall bore of the contact tip when assembled.

14. The contact tip of claim 13, wherein the second central bore includes a tapered entry portion having a diameter greater than the first central bore.

15. The contact tip of claim 1, wherein the body is configured to conduct current passing through the end assembly, and the cap is configured to resist high temperatures at the weld site to increase durability of the contact tip.

16. A method of assembling a contact tip for use in an end assembly for an arc welding device of a type including a gooseneck having an internal passageway for conducting a shielding gas, a diffusor coupled to the gooseneck, a nozzle extending from the gooseneck, and a wire guide for guiding a consumable wire electrode, the method comprising:
providing a body made of a first material and defining a first end of a contact tip configured to mate with an end assembly of a welding system;
providing a cap made of a second material different from the first material and defining a second end of the contact tip and configured for feeding a weld wire therefrom to a weld site, the cap sized and shaped to mate with the body, wherein the cap is a separate piece that is assembled with the body to define the contact tip;
inserting a projecting boss of the body into a corresponding bore of the cap;
fixing the cap to the body and defining the contact tip in an assembled state;
defining an overall central bore defined by the body and the cap and extending fully through the contact tip in the assembled state, the overall central bore configured to feed a weld wire therethrough;
wherein the first material of the body has higher conductivity than the second material of the cap; and
wherein the second material of the cap has a higher temperature resistance than the first material of the body.

17. The method of claim 16, wherein the bore of the cap includes internal threads and the boss of body includes external threads, and the step of inserting includes threading the cap onto the body.

18. The method of claim 17, wherein the boss of the body includes a non-threaded end portion and the bore of the cap includes a non-threaded tip cavity, wherein the non-threaded end portion passes through the internal threads of the cap and into the tip cavity.

19. The method of claim 18, wherein the non-threaded end portion is longer than the tip cavity, wherein the fixing step includes axially compressing the end portion and radially expanding the end portion in response to threading the cap onto the body.

20. The method of claim 17 further comprising compressing an outer surface of the cap after fixing the cap to the body and deforming the internal and external threads.
